(19) United States
(12) Patent Application Publication
(10) Pub. No.: US 2021/0156316 A1
(43) Pub. Date: May 27, 2021

(54) ROTATING COMPONENT SENSING SYSTEM

(71) Applicant: Dana TOMESCU, Brampton (CA)

(72) Inventor: Dana TOMESCU, Brampton (CA)

(21) Appl. No.: 16/696,465

(22) Filed: Nov. 26, 2019

(51) Int. Cl. F02C 9/22

(52) U.S. Cl. CPC F02C 9/22; F05D 2240/24; F05D 2270/80

(57) ABSTRACT

A sensing system and method for an engine rotor are provided. The rotor is rotatable about a longitudinal axis and at least one rotating member is coupled to rotate with the rotor about the axis. The rotating member comprises at least one marker affixed to a core. The core is made of a first material having a first magnetic permeability and the marker comprises a second material having a second magnetic permeability greater than the first magnetic permeability. At least one sensor is mounted adjacent the rotating member and configured to produce at least one first signal in response to detecting passage of the marker as the rotating member rotates about the axis. A control unit is communicatively coupled to the sensor and configured to generate, in response to the first signal received from the sensor, a second signal indicative of at least a rotational speed of the rotor.

### CROSS REFERENCE TO RELATED APPLICATIONS

This patent application claims priority of U.S. provisional Application Ser. No. 62/896,157, filed on Sep. 5, 2019, the entire contents of which are hereby incorporated by reference.

### TECHNICAL FIELD

The present disclosure relates generally to gas turbine engines, and more specifically to sensing systems for gas turbine engines.

### BACKGROUND OF THE ART

Engine speed is typically measured via dedicated speed sensors. However, existing engine sensing systems sometimes require additional features, such as dedicated readable markers, for the sole purpose of speed sensing. This can however negatively impact engine performance, in addition to increasing the weight and size of the overall system. In addition, existing speed measurement systems are often complex and cumbersome and may inaccurately determine engine speed under certain circumstances.

Therefore, improvements are needed.

### SUMMARY

In accordance with a broad aspect, there is provided a sensing system for a rotor of an engine, the rotor rotatable about a longitudinal axis, the system comprising at least one rotating member coupled to rotate with the rotor about the longitudinal axis, the at least one rotating member comprising a core and at least one marker affixed to the core, the core made of a first material having a first magnetic permeability and the at least one marker comprising a second material having a second magnetic permeability greater than the first magnetic permeability, at least one sensor mounted adjacent the at least one rotating member and configured to produce at least one first signal in response to detecting passage of the at least one marker as the at least one rotating member rotates about the axis, and a control unit communicatively coupled to the at least one sensor and configured to generate, in response to the at least one first signal received from the at least one sensor, a second signal indicative of at least a rotational speed of the rotor.

In some embodiments, the at least one rotating member comprises at least one blade of the engine.

In some embodiments, the second material is applied to at least a tip of the at least one blade to provide the at least one marker.

In some embodiments, the second material is applied to an entire exposed surface of the at least one blade to provide the at least one marker.

In some embodiments, the rotor is an aircraft-bladed rotor having an adjustable blade pitch angle, and the at least one rotating member comprises a feedback device coupled to rotate about the longitudinal axis with the rotor and to be displaced axially along the axis with adjustment of the blade pitch angle.

In some embodiments, the feedback device comprises a plurality of detectable features spaced around a circumference thereof, and at least one of the plurality of detectable features comprises the second material to provide the at least one marker.

In some embodiments, the second material is applied to at least part of the at least one of the plurality of detectable features to provide the at least one marker.

In some embodiments, the plurality of detectable features comprises a first plurality of projections extending from a surface of the feedback device and oriented substantially parallel to the longitudinal axis and at least one second projection extending from the surface and positioned between two adjacent first projections, the at least one second projection disposed on the surface at an angle relative to the first plurality of projections, and a selected one of the first projections comprises the second material.

In some embodiments, the control unit is configured to generate the second signal indicative of the blade pitch angle and the rotational speed of the rotor.

In some embodiments, the at least one rotating member comprises a torque shaft having a plurality of circumferentially spaced teeth, and at least one of the plurality of teeth comprises the second material to provide the at least one marker.

In some embodiments, the second material is applied to at least part of the at least one of the plurality of teeth to provide the at least one marker.

In some embodiments, the at least one of the plurality of teeth is fabricated from the second material.

In some embodiments, the at least one marker is provided by one of coating at least part of the at least one rotating member with the second material and plating at least part of the at least one rotating member with the second material.

In some embodiments, the second material has a relative magnetic permeability between 80,000 and 100,000.

In accordance with another broad aspect, there is provided a sensing method for a rotor of an engine, the rotor rotatable about a longitudinal axis, the method comprising receiving at least one first signal from at least one sensor positioned adjacent at least one rotating member, the at least one rotating member coupled to rotate with the rotor about the longitudinal axis and comprising a core and at least one marker made affixed to the core, the core made a first material having a first magnetic permeability and the at least one marker comprising a second material having a second magnetic permeability greater than the first magnetic permeability, the at least one first signal produced by the at least one sensor in response to detecting passage of the at least one marker as the at least one rotating member rotates about the axis, and processing the at least one first signal to generate a second signal indicative of at least a rotational speed of the rotor.

In some embodiments, the at least one first signal is received from the at least one sensor positioned adjacent the at least one rotating member comprising at least one blade of the engine, the second material applied to at least part of the at least one blade to provide the at least one marker.

In some embodiments, the at least one first signal is received from the at least one sensor positioned adjacent the at least one rotating member comprising a feedback device coupled to rotate about the axis with the rotor and to be displaced axially along the axis with adjustment of a blade pitch angle of the rotor, the feedback device comprising a plurality of detectable features spaced around a circumference thereof, and at least one of the plurality of detectable features comprises the second material to provide the at least one marker.

In some embodiments, the at least one first signal is received from the at least one sensor positioned adjacent the at least one rotating member comprising a torque shaft having a plurality of circumferentially spaced teeth, at least one of the plurality of teeth comprising the second material to provide the at least one marker.

Features of the systems, devices, and methods described herein may be used in various combinations, in accordance with the embodiments described herein.

### BRIEF DESCRIPTION OF THE DRAWINGS

Reference is now made to the accompanying figures in which:

FIG. 1A is a schematic cross-sectional view of an example turbofan gas turbine engine, in accordance with one embodiment;

FIG. 1B is an isometric side view of a fan blade of the engine of FIG. 1A having a high magnetic permeability marker, in accordance with one embodiment;

FIG. 2A is a schematic cross-sectional view of an example turboprop gas turbine engine, in accordance with one embodiment;

FIG. 2B is a schematic diagram of an example feedback sensing system for the engine of FIG. 2A, in accordance with one embodiment;

FIG. 2C is a schematic diagram of the propeller of FIG. 2A with the feedback device of FIG. 2B, in accordance with an embodiment;

FIG. 2D is a schematic bottom view of the feedback device of FIG. 2B showing detectable features, in accordance with one embodiment;

FIG. 2E is a schematic diagram of a high magnetic permeability marker provided on the feedback device of FIG. 2B, in accordance with an embodiment;

FIG. 3 is a block diagram of a computing device for implementing the control unit of FIG. 1A or FIG. 2B, in accordance with an illustrative embodiment.

It will be noted that throughout the appended drawings, like features are identified by like reference numerals.

### DETAILED DESCRIPTION

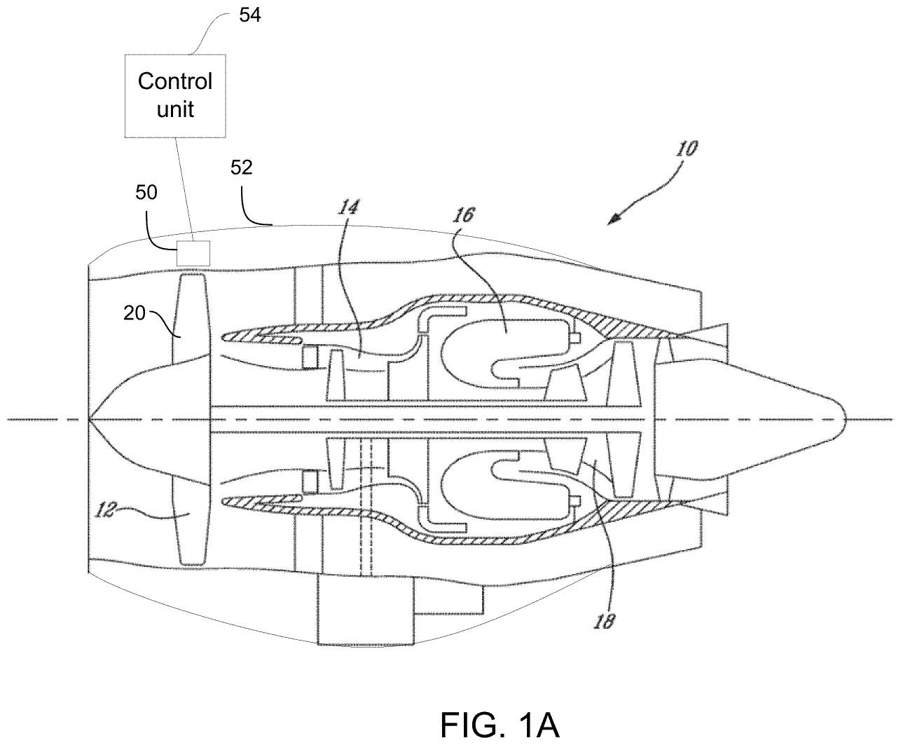

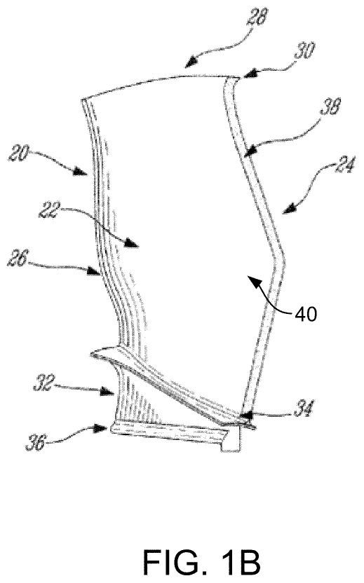

FIG. 1A illustrates a gas turbine engine 10, and more particularly a turbofan engine, in accordance with one embodiment. The engine 10 generally comprises, in serial flow communication, a fan 12 through which ambient air is propeller, a compressor section 14 for pressurizing the air, a combustor 16 in which the compressed air is mixed with fuel and ignited for generating an annular stream of hot combustion gases, and a turbine section 18 for extracting energy from the combustion gases. The fan 12 comprises a plurality of blades 20, as will be described in further detail below.

Referring to FIG. 1B in addition to FIG. 1A, a fan blade 20 of the fan 12, is shown. The fan blade 20 has an airfoil 22 with a leading edge 24, trailing edge 26, tip 28 and beak 30, as well as a root 32 having a platform 34 and a blade fixing or dovetail 36 for engaging a fan hub (not shown). In this example, the fan blade 20 is composed of a core (or base) substrate material, which may comprise any suitable material including, but not limited to, titanium (though alternately another suitable material may be used, such as titanium alloy for example) is used as the base substrate material. The fan blade 20 also comprises a material 40 (referred to herein as a “high magnetic permeability material”), which has a magnetic permeability that is greater than the magnetic permeability of the base substrate material. It should be understood that, as used herein, the term “high magnetic permeability material” does not necessarily denote a particular value for magnetic permeability, nor a particular range of magnetic permeability values. Rather, reference to the high magnetic permeability material is in contrast with the base substrate material that makes up the core of the rotating component (e.g., fan blade as in 20, feedback device as in 204) described herein.

Provision of the high magnetic permeability material 40 on the fan blade 20 results in creation of at least one marker (referred to herein as at least one “high magnetic permeability marker”) that is detectable by a sensor 50 embedded in a fan case 52 of the engine 10. The fan case 52 may be designed and/or modified to remove metallic material that may interfere with the sensor 50. The fan case 52 may be made with a non-ferromagnetic material, e.g. resulting in a composite enclosure that maintains airflow and does not interfere with the signal from the sensor 50. The sensor 50 may be any suitable sensor (e.g., an inductive sensor) configured to detect the presence (or the passage) of the high magnetic permeability marker(s) in a sensing zone of the sensor 50. When a high magnetic permeability marker is present in the sensing zone, or passes through the sensing zone during rotation of the fan blades 50, this results in a change in magnetic flux within the sensing zone, resulting in the sensor 50 producing a signal pulse that forms part of a sensor signal (e.g., an electrical signal, a digital signal, an analog signal, or the like). A control unit 54 communicatively coupled to the sensor 212 may then receive the sensor signal from the sensor 212 and process the received sensor signal in order to determine a rotational speed of the engine 10. In one embodiment, the control unit 54 generates, based on the sensor signal, a signal indicative of the rotational speed.

In one embodiment, Mu-metal (which has relative magnetic permeability values of 80,000 to 100,000 compared to several thousand for ordinary steel) is used as the high magnetic permeability material. As known to those skilled in the art, materials, such as Mu-metal, provide a path for magnetic field lines around the area covered by the material. It should however be understood that materials other than Mu-metal may apply. Materials including, but not limited to, ferrite ceramics, permalloy, and supermalloy, may apply.

The high magnetic permeability material 40 is applied to at least part of the fan blade 20, such that the fan blade 20 fully or partially comprises the high magnetic permeability material 40. In one embodiment, the high magnetic permeability material 40 covers the entire blade surface, including the airfoil 22, platform 34, and dovetail 36 portions. In another embodiment, the high magnetic permeability material 40 is applied to a part of the airfoil 22 (e.g., the tip 28, beak 30, and part of the airfoil 22 up to the edge of the platform 34, but excluding the platform 34 and dovetail 36).

The surface area of the fan blade 20 to which the high magnetic permeability material 40 is applied may depend on a number of factors. For example, applying the high magnetic permeability material 40 on the entire blade surface may allow to maximize the strength of the signal generated by sensor 50. Alternatively, applying the high magnetic permeability material 40 to the part of the airfoil 22 adjacent the sensor(s) 212) may allow to increase magnetic flux. It should however be noted that, in order to prevent modification of the profile of the fan blade 20, it may be desirable to apply the high magnetic permeability material 40 to the entire exposed surface of the fan blade 20. It should also be understood that one or more of the fan blades 20 may be provided with the high magnetic permeability material 40. The number of fan blades 20 having the high magnetic permeability material 40 may depend on factors including, but not limited to, engine configuration and required accuracy for engine speed calculation. Indeed, increasing the number of fan blades 20 having the high magnetic permeability material 40 may allow to increase resolution.

The high magnetic permeability material 40 may be applied to the fan blade(s) 20 using any suitable process. The high magnetic permeability material 40 may be coated (e.g., using traditional coating, intermolecular coating, or the like) on at least part of the fan blade(s) 20, as will be discussed further below. Alternatively, the high magnetic permeability material 40 may be plated (e.g., using electro-plating, electro-forming, or the like) on at least part of the fan blade(s) 20.

In one embodiment, an intermolecular coating, such as a nanocrystalline metallic coating (also referred to herein as a nano-metal coating), is applied to at least part of the fan blade(s) 20. For example, the nano-metal coating may be applied to the base substrate material of the fan blade(s) 20 so as to form an outer shell that envelopes (in part or in full) the fan blade core. The nano-metal coating may thus define at least part of an exposed (or outer) surface of the fan blade(s) 20. The nano-metal coating may include a single layer topcoat of a nano-scale, fine grained high magnetic permeability metal. The nano-metal coating may have an average grain size at least in the range of between about 1 nm and about 5000 nm. In a particular embodiment, the nano-metal coating has an average grain size of between about 10 nm and about 500 nm. More preferably, in another embodiment, the nano-metal coating has an average grain size of between about 10 nm and about 50 nm, and more preferably still an average grain size of between about 10 nm and about 25 nm. A thickness of a single layer of nano-metal coating may range from about 0.001 inch (0.0254 mm) to about 0.020 inch (0.508 mm) in thickness. The thickness of the nano-metal coating is therefore smaller than that of traditional coatings, which may allow to maintain required engine tip clearances.

Any suitable number of layers of nano-metal coating may be provided, including, but not limited to, one or more layers of different grain size, and/or a thicker layer having graded average grain size and/or graded composition within the layer. It should be understood that the properties (e.g., average grain size, thickness) of the nano-metal coating may depend on the clearance available in the design of the fan blade(s) 20 as well as on the required measurement (e.g., speed measurement) accuracy. In addition, the properties of the nano-metal coating may be modified in specific regions of the coating (i.e. may not be uniform throughout the fan blade(s) 20) in order to provide a structurally optimum fan blade 20. For example, the nano-metal coating may be formed thicker in regions known to be more structural and/or more erosion demanding of the fan blade(s) 20 and thinner in other less demanding regions.

Any suitable coating process, including, but not limited to, a plating technique, may be used to deposit the high magnetic permeability material 40. In one embodiment, the nano-metal coating is applied directly to the fan blade(s) 20. Auxiliary processes to improve plating adhesion of the nano-metal coating to the fan blade(s) 20 may also be used. Such processes may include, but are not limited to, surface activation, surface texturing, applied resin and surface roughening. Alternatively, a layer of intermediate bond coat may be disposed (e.g., by electroplating or other suitable process) on the fan blade(s) 20 before the nano-metal coating is applied thereto, thereby improving adhesion and the coating process. Other embodiments may apply.

In one embodiment, applying the high magnetic permeability material 40 to the fan blade(s) 20 allows to use the fan blade(s) 20 directly for speed sensing and detection, thus alleviating the need for a separate speed sensor (e.g., N1 probe, not shown) to measure engine speed. This may in turn result in weight savings and reduced complexity. In addition, speed detection may be performed using the high magnetic permeability marker(s) provided on the fan blade(s) 20 without requiring the blade geometry (or profile) to be modified. This allows for critical tip clearances to be maintained and in turn for overall engine and aircraft performance to be improved.

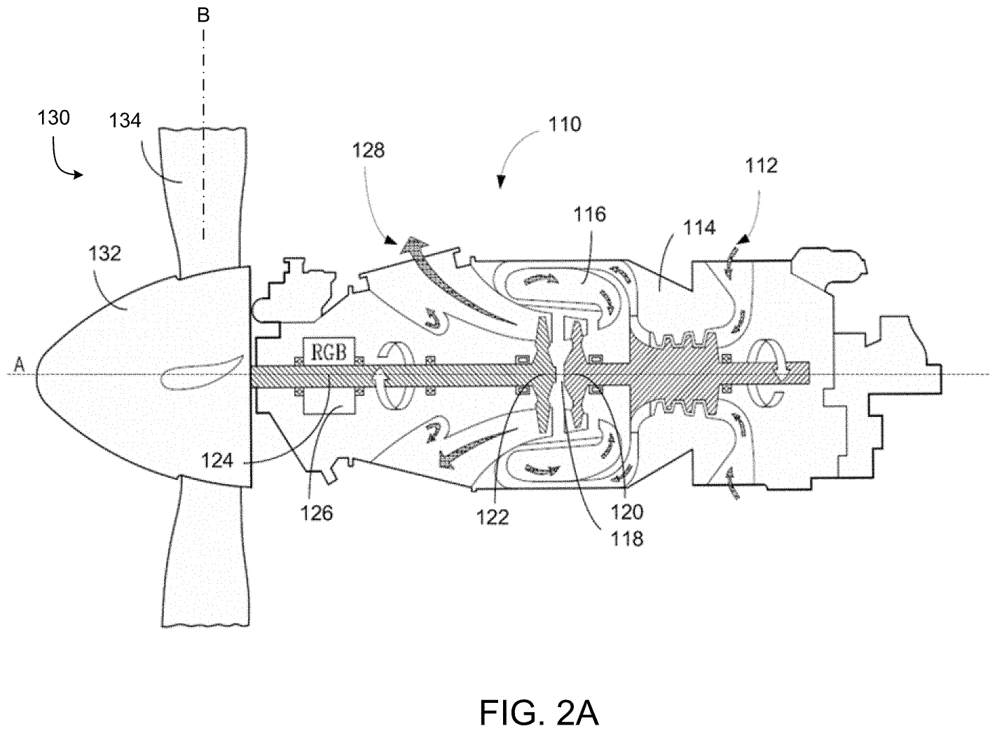

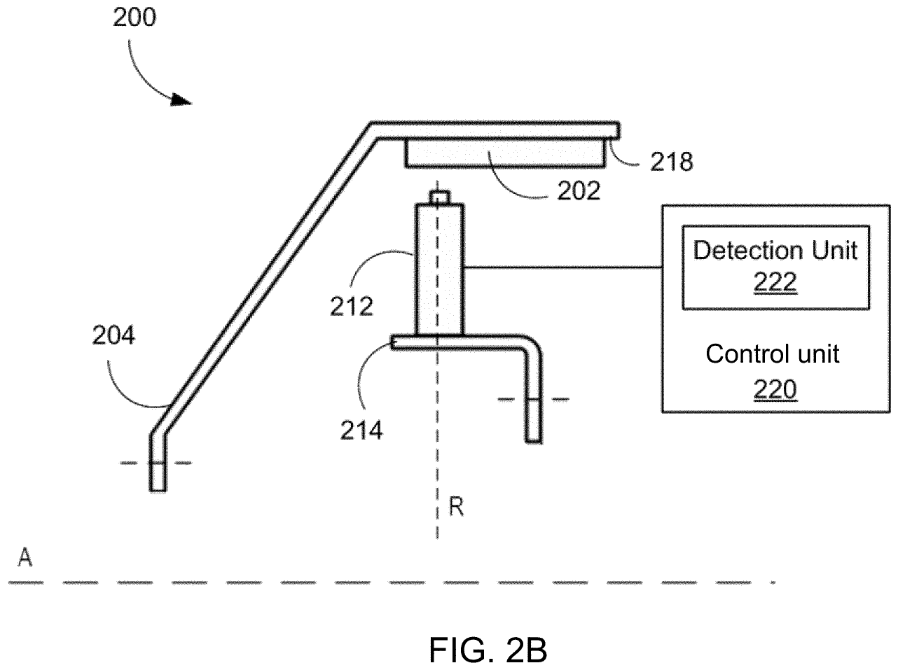

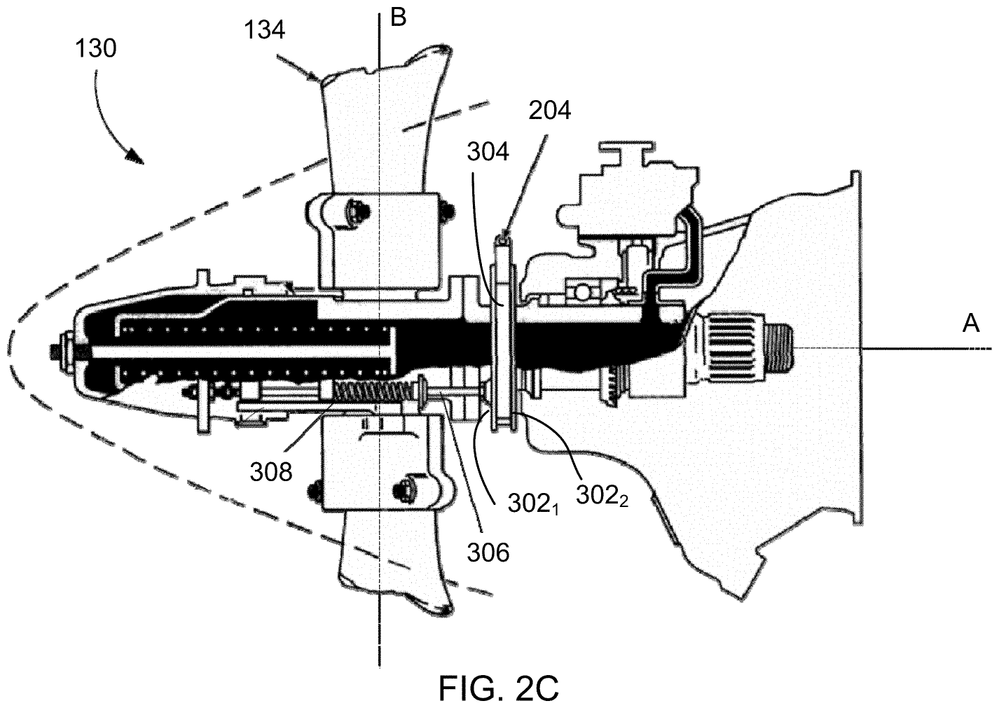

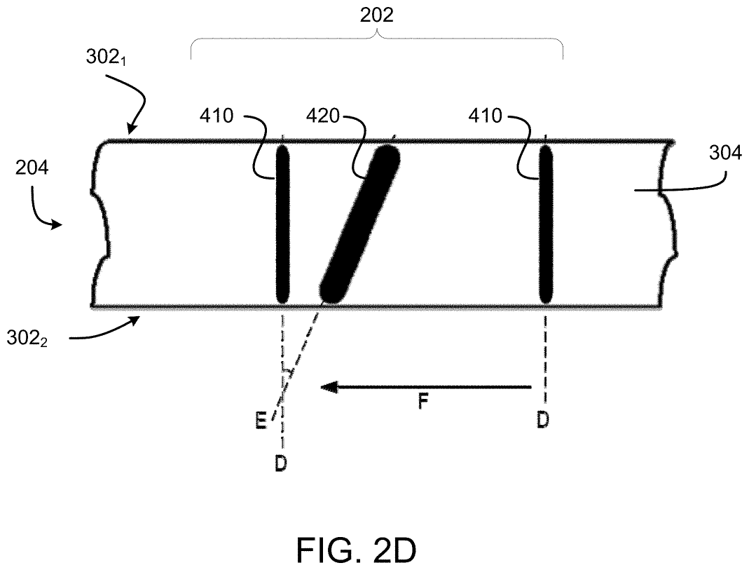

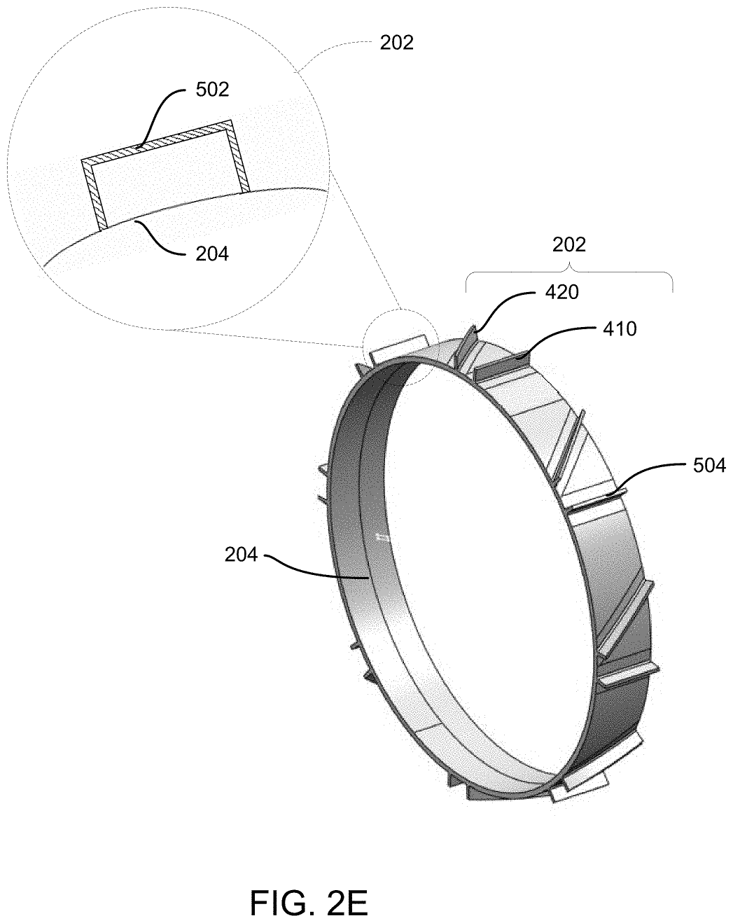

It should be understood that, while reference is made herein to a fan blade as in 20 being provided with a high magnetic permeability material as in 40, other types of engine blades having critical tip clearances, including, but not limited to, compressor blades and turbine blades, may also apply. Moreover, rotating components other than blades may be provided with the high magnetic permeability material 40. In fact, any rotating component or element that is provided in an engine (e.g., engine 10 in FIG. 1A, engine 110 in FIG. 2A, Auxiliary Power Unit (APU), or the like), whether used to determine rotational speed or blade angle of a rotor, may be provided with the high magnetic permeability material as in 40. In one embodiment, the rotating component is a component that is operatively coupled to the rotor of the engine and is configured to rotate with the rotor, and one or more sensor(s) may be positioned proximate the rotating component (e.g., for speed detection purposes). The rotating component illustratively has critical tip clearances or critical air gap requirements. The rotating component may include, but is not limited to, a feedback device that is part of a blade angle feedback sensing system for pitch-adjustable blades of a bladed rotor (as discussed further below with reference to FIGS. 2A to 2E) and a torque shaft that is used for speed sensing (as discussed further below). Any suitable process (including, but not limited to, the processes described herein above) may be used to provide the rotating component with the high magnetic permeability material as in 40.

FIG. 2A depicts a gas turbine engine 110 of a type typically provided for use in subsonic flight, and more particularly a turboprop engine, in accordance with another embodiment. The engine 110 comprises an inlet 112 through which ambient air is propelled, a compressor section 114 for pressurizing the air, a combustor 116 in which the compressed air is mixed with fuel and ignited for generating an annular stream of hot combustion gases, and a turbine section 118 for extracting energy from the combustion gases.

The turbine section 118 comprises a compressor turbine 120, which drives the compressor assembly and accessories, and at least one power or free turbine 122, which is independent from the compressor turbine 120 and rotatingly drives a rotor shaft (also referred to herein as a propeller shaft or an output shaft) 124 about a propeller shaft axis ‘A’ through a reduction gearbox (RGB) 126. Rotation of the output shaft 124 is facilitated by one or more bearing assemblies (not illustrated), which can be disposed within the RGB 126 or at any other suitable location. Hot gases may then be evacuated through exhaust stubs 128. The gas generator of the engine 110 comprises the compressor section 114, the combustor 116, and the turbine section 118.

A rotor, in the form of a propeller 130 through which ambient air is propelled, is hosted in a propeller hub 132. The rotor may, for example, comprise the propeller 130 of a fixed-wing aircraft, or a main (or tail) rotor of a rotary-wing aircraft such as a helicopter. The propeller 130 may comprise a plurality of circumferentially-arranged blades 134 connected to the hub 132 by any suitable means and extending radially therefrom. The blades 134 are also each rotatable about their own radial axes ‘B’ through a plurality of blade angles, which can be changed to achieve modes of operation, such as feather, full reverse, and forward thrust.

With reference to FIG. 2B, a feedback sensing system 200 for pitch-adjustable blades of bladed rotors of aircraft will now be described. The system 200 may be used for sensing a feedback device (also referred to as a feedback ring or phonic wheel) 204 of an aircraft propeller. It should however be understood that, although the system 200 is described and illustrated herein with reference to an aircraft propeller, such as the propeller 130 of FIG. 2A, the system 200 may apply to other types of rotors, such as those of helicopters. The systems and methods described herein are therefore not limited to being used for aircraft propellers.

In some embodiments, the system 200 provides for detection and measurement of rotational velocity of one or more rotating elements of the engine 110 and of propeller blade angle on propeller systems, such as the propeller 130 of FIG. 2A. The system 200 may interface to existing mechanical interfaces of typical propeller systems to provide a digital detection for electronic determination of the propeller blade angle. It should be noted that, although the present disclosure focuses on the use of the system 200 and the feedback device 204 in gas-turbine engines, similar techniques can be applied to other types of engines, including, but not limited to, electric engines and hybrid electric propulsion systems having a propeller driven in a hybrid architecture (series, parallel, or series/parallel) or turboelectric architecture (turboelectric or partial turboelectric).

The system 200 comprises an annular member 204 and one or more sensors 212 positioned proximate the annular member 204. Annular member 204 (referred to herein as a feedback device) has a plurality of circumferentially-spaced apart and detectable features (also referred to as position markers or teeth) 202 disposed thereon for detection by sensor(s) 212. In some embodiments, the detectable features 202 and sensor(s) 212 may be disposed on a radially-outer side of feedback device 204. Alternatively, detectable features 202 and sensor(s) 212 could be disposed on a radially-inner side of feedback device 204. Several detectable features 202 may be spaced equiangularly about the perimeter (also referred to herein as the ‘circumference’) of the feedback device 204. Other embodiments may apply.

In some embodiments, the feedback device 204 is mounted for rotation with propeller 130 and to move axially along rotation axis A to a plurality of axial positions, with adjustment of the blade angle of the blades (reference 134 in FIG. 2A) of the propeller 130, and the one or more sensors 212 are fixedly mounted to a static portion of the engine 110. An axial position of the feedback device 204 may then correspond to a respective angular (pitch) position of the blades and the detectable features 202 may be useful for detecting the axial position of the feedback device 204 as the feedback device 204 and bladed rotor 130 rotate. The feedback device 204 may therefore be useful for detecting the angular position of the adjustable blades by way of correlation. In other embodiments, the one or more sensors 212 are mounted for rotation with propeller 130 and to move axially with adjustment of the blade angle of the blades 134 of the propeller 130, and the feedback device 204 is fixedly mounted to a static portion of the engine 110.

In the example illustrated in FIG. 2B, a side view of a portion of feedback device 204 and sensor 212 is shown. The sensor (or sensors) 212 is mounted to a flange 214 of a housing of the reduction gearbox 126, so as to be positioned adjacent the plurality of detectable features 202. In some embodiments, the sensor 212 is secured to the propeller 130 so as to extend away from the flange 214 and towards the detectable features 202 along a radial direction, identified in FIG. 2B as direction ‘R’. Sensor 212 and flange 214 may be fixedly mounted, for example to the housing of the reduction gearbox 126, or to any other static element of the engine 110, as appropriate.

In some embodiments, a single sensor 212 is mounted in close proximity to the rotating component 201. In some other embodiments, in order to provide redundancy as well as dual-signal sources at multiple locations, one or more additional sensors, which may be similar to the sensor 212, are provided.

The system 200 also includes a control unit 220 communicatively coupled to the one or more sensors 212. The sensor(s) 212 are configured for producing a sensor signal which is transmitted to or otherwise received by the control unit 220, for example via a detection unit 222 thereof. The sensor signal can be an electrical signal, digital or analog, or any other suitable type of signal. In some embodiments, the sensor(s) 212 produce a signal pulse in response to detecting the presence of the detectable feature 202 (and more particularly of at least one high magnetic permeability marker, as will be discussed further below) in a sensing zone of the sensor 212.

For example, the sensor 212 may be an inductive sensor that operates on detecting changes in magnetic flux, and may have a sensing zone which encompasses a circular or rectangular area or volume in front of the sensor 212. When a detectable feature 202 (and more particularly one or more high magnetic permeability markers thereof) is present in the sensing zone, or passes through the sensing zone during rotation of the feedback device 204, the magnetic flux in the sensing zone is varied by the presence of the detectable feature 202, and the sensor 212 can produce a signal pulse, which forms part of the sensor signal. It should be understood that, in one embodiment, the amplitude of a signal pulse produced by the sensor 212 in response to detection of a high magnetic permeability marker is greater than the amplitude of a signal pulse produced by the sensor 212 in response to detection of a regular detectable feature 202 (i.e. a detectable feature 202 not provided with the high magnetic permeability material). The sensor 212 may also be any other suitable sensor, such as a Hall sensor or a variable reluctance sensor. Still other embodiments are considered. In one embodiment, regardless of the type of sensor(s) 212, provision of the high magnetic permeability marker(s) illustratively increases sensor signal pulse, such that the configuration sensor(s) 212 may be optimized (e.g. to have fewer windings), thereby decreasing the weight and size of the sensor(s) 212.

The detectable features 202 provided on the feedback device 204 may be made of any suitable material which would cause the passage of the detectable features 202 near the sensor 212 to provide a change in magnetic permeability within the magnetic field generated by the sensor 212. As will be discussed further below, one or more detectable features 202 may be made of (or provided with) a high magnetic permeability material and are referred to herein as “high magnetic permeability markers”.

With additional reference to FIG. 2C, in some embodiments the feedback device 204 is embodied as a circular disk (or annular member) which rotates as part of the engine 110, for example with the propeller shaft 124 or with the propeller 130. The feedback device 204 comprises opposing faces (not shown) having outer edges 302₁, 302₂ and defines a surface 304 (referred to herein as a “root surface”) which extends between the opposing faces and circumscribes them. Put differently, the root surface 304 of the feedback device 204 is the outer periphery of the feedback device 204 which spans between the two opposing faces and the root surface 304 intersects the faces at the edges 302₁, 302₂. In these embodiments, the detectable features 202 can take the form of projections which extend from the root surface 304.

The detectable features 202 may comprise a plurality of first projections (not shown) arranged along a direction substantially transverse to the opposing faces and substantially equally spaced from one another on the root surface 304. The detectable features 202 may also comprise one or more second projections (not shown) each positioned between two adjacent first projections. Each second projection is illustratively oriented along a direction, which is at an angle relative to the direction along which the first projections are arranged. The angle can be any suitable value between 1° and 89°, for example 30°, 45°, 60°, or any other value, as appropriate. It should be noted, however, that in some other embodiments the second projection(s) can be co-oriented with the first projections. It should also be noted that in some embodiments, each second projection can be substituted for a groove or inward projection, as appropriate. In addition, in some embodiments, the feedback device 204 includes only a single second projection while, in other embodiments, the feedback device 204 can include more than one second projection. In the latter case, the second projections can be oriented along a common orientation or along one or more different orientations and each second projection can be located at substantially a midpoint between two adjacent first projections or can be located close to a particular one of two adjacent first projections. Other embodiments may apply.

In one embodiment, the detectable features 202 are integrally formed with the feedback device 204 so that the feedback device 204 may have a unitary construction. In another embodiment, the detectable features 202 are manufactured separately from the feedback device 204 and attached thereto using any suitable technique, such as welding or the like.

It should also be noted that, although the present disclosure focuses primarily on embodiments in which the detectable features 202 are projections, other embodiments are also considered. A detectable feature 202 can then be a portion of the feedback device 204 which is made of a different material, or to which is applied a layer of a different material.

The signal pulses produced by the sensor(s) 212, which form part of the electrical signal received by the control unit 220, can be used to determine various operating parameters of the engine 110 and the propeller 130. The regular spacing of the first projections can, for example, be used to determine a speed of rotation of the feedback device 204. In addition, the second projection(s) can be detected by the sensor 212 to determine a blade angle of the propeller 130. A feedback signal may thus be generated accordingly by the control unit 220, based on the sensor signal.

With continued reference to FIG. 2C, the feedback device 204 is supported for rotation with the propeller 130, which rotates about the longitudinal axis A. The feedback device 204 is also supported for longitudinal sliding movement along the axis A, e.g. by support members, such as a series of circumferentially spaced feedback rods 306 that extend along the axis A. A compression spring 308 surrounds an end portion of each rod 306.

As depicted in FIG. 2C, the propeller 130 comprises a plurality of angularly arranged blades 134, each of which is rotatable about a radially-extending axis B through a plurality of adjustable blade angles, the blade angle being the angle between the chord line (i.e. a line drawn between the leading and trailing edges of the blade) of the propeller blade section and a plane perpendicular to the axis of propeller rotation. In some embodiments, the propeller 130 is a reversing propeller, capable of operating in a variety of modes of operation, including feather, full reverse, and forward thrust. Depending on the mode of operation, the blade angle may be positive or negative: the feather and forward thrust modes are associated with positive blade angles, and the full reverse mode is associated with negative blade angles.

Referring now to FIG. 2D in addition to FIG. 2C, the feedback device 204 illustratively comprises detectable features 202, which, in one embodiment, can take the form of projections which extend from the root surface 304. As the feedback device 204 rotates, varying portions thereof enter, pass through, and then exit the sensing zone of the sensor (reference 212 in FIG. 2B). From the perspective of the sensor 212, the feedback device 204 moves axially along axis A and rotates about direction F.

In one embodiment (illustrated in FIG. 2D), the detectable features 202 include a plurality of projections 410 which are arranged along a direction which is substantially transverse to the opposing edges 302₁, 302₂. Although only two projections 410 are illustrated in FIG. 2D, it should be understood that any suitable number of projections 410 may be present across the whole of the root surface 304. The projections 410 can be substantially equally spaced from one another on the root surface 304. In addition, the projections 410 are of substantially a common shape and size, for example having a common volumetric size. In some embodiments, only some of the projections 410 may have extensions whereas others may not and the projections 410 may not always be equally spaced around the root surface 304.

The feedback device 204 also includes at least one supplementary projection 420 which is positioned between two adjacent ones of the projections 410. In the embodiment depicted in FIG. 2D, the projection 420 is oriented along a direction ‘E’, which is at an angle relative to direction ‘D’. The angle between directions ‘D’ and ‘E’ can be any suitable value between 1° and 89°, for example 30°, 45°, 60°, or any other value, as appropriate. It should be noted, however, that in some other embodiments the supplementary projection 420 can be co-oriented with the projections 410, for instance along direction ‘D’.

In some embodiments, the feedback device 204 includes only a single supplementary projection 420. In other embodiments, the feedback device 204 can include two, three, four, or more supplementary projections 420. In embodiments in which the feedback device 204 includes more than one supplementary projection 420, the supplementary projections can all be oriented along a common orientation, for instance direction ‘E’, or can be oriented along one or more different orientations. The projection 420 can be located at substantially a midpoint between two adjacent projections 410, or, as shown in FIG. 2D, can be located close to a particular one of two adjacent projections 410.

Referring now to FIG. 2E, in one embodiment, a material 502 (referred to herein as a “high magnetic permeability material”) is applied to at least part of the feedback device 204 in order to provide the high magnetic permeability markers to be detected by the sensor(s) (reference 212 in FIG. 2B) for blade angle and/or rotational speed determination. The feedback device 204 may indeed comprise a core (not shown) made of a metallic material having a lower magnetic permeability than that of the high magnetic permeability material 502. Provision of the high magnetic permeability material 502 may alleviate the need for additional speed sensor features (e.g., additional detectable features provided on the feedback device 204 for the sole purpose of speed sensing). The high magnetic permeability material 502 may have the same characteristics as the high magnetic permeability material described above with reference to FIG. 1A and FIG. 1B. In one embodiment, the high magnetic permeability material 502 is Mu-metal. Other embodiments may apply.

In one embodiment, the high magnetic permeability material 502 may be applied (e.g., using coating, plating, or the like, as discussed herein above) to an entire exposed surface (not shown) of the feedback device 204. In another embodiment, the high magnetic permeability material 502 may be applied to one or more of the detectable features 202 (as illustrated in FIG. 2E).

In one embodiment, the high magnetic permeability material 502 may be applied to a given one of the first projections 410, the given projection 410 then serving the purpose of sensing speed and providing information regarding the axial positioning of the feedback device 204. The number of high magnetic permeability markers (i.e. the number of detectable features 202 to which the high magnetic permeability material 502 is applied) may depend on factors including, but not limited to, engine configuration and required accuracy for engine speed and/or blade angle calculation. Indeed, as discussed above, providing an increased number of high magnetic permeability markers allows to increase resolution.

In yet another embodiment, the high magnetic permeability material 502 may only be applied to an upper portion of the feedback device's exposed surface. In particular, the high magnetic permeability material 502 may be applied to a top surface 504 of one or more of the detectable features 202. Other embodiments may apply. The location of the high magnetic permeability marker(s) may depend on a number of factors. For example, applying the high magnetic permeability material on the entire exposed surface of the feedback device 204 may allow to maximize the strength of the signal received from the sensor(s) 212. Also, applying the high magnetic permeability material to a top surface and sides of the feedback device 204 (the top surface and sides being adjacent the sensor(s) 212) may allow to increase magnetic flux.

In another embodiment, a high magnetic permeability material is applied to one or more radially disposed teeth of a torque shaft (not shown) used for speed sensing. The torque shaft may be associated with one or more speed sensors. The torque shaft may be configured to be actuated with a rotational input from a rotor shaft (e.g., rotor shaft 124 in FIG. 2A) and may accordingly rotate about a rotation axis (reference A in FIG. 2A). In operation, an angular deflection occurs in the torque shaft and the angular deflection is measured relative to zero deflection of a reference shaft. The measurement is then transmitted to a control unit that in turn provides a signal indicative of the engine rotational speed. In order to improve measurement accuracy, the high magnetic permeability material (not shown) may be applied to one or more of the teeth, thereby providing high magnetic permeability markers for detection by the sensor(s). It should be understood that the high magnetic permeability marker(s) may alternatively be provided by fabricating at least one of the teeth from the high magnetic permeability material. The torque shaft may therefore comprise a core made of a metallic material and the high magnetic permeability marker(s) affixed to the core.

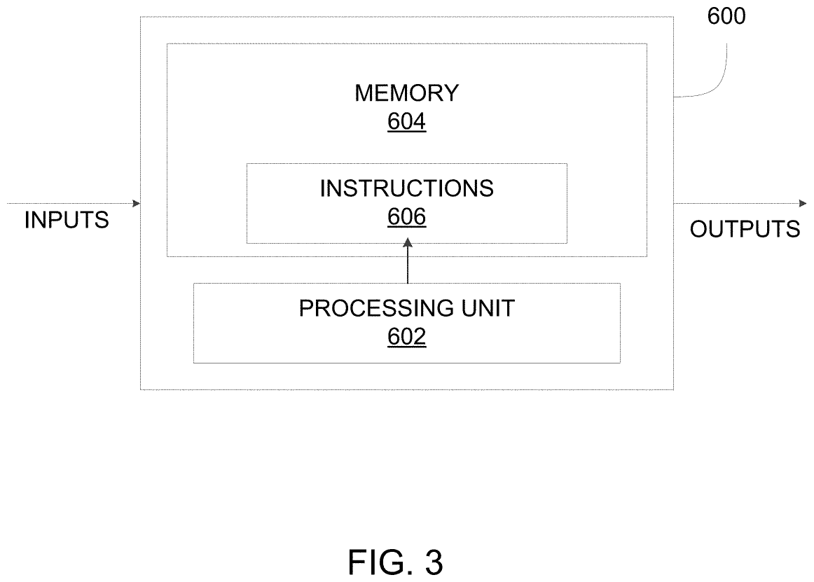

FIG. 3 is an example embodiment of a computing device 600 for implementing the control units (references 54 and 220) described above (with reference to FIG. 1A and FIG. 2B, respectively). The computing device 600 comprises a processing unit 602 and a memory 604 which has stored therein computer-executable instructions 606. The processing unit 602 may comprise any suitable devices configured to cause a series of steps to be performed such that instructions 606, when executed by the computing device 600 or other programmable apparatus, may cause the functions/acts/steps specified in the method described herein to be executed. The processing unit 602 may comprise, for example, any type of general-purpose microprocessor or microcontroller, a digital signal processing (DSP) processor, a CPU, an integrated circuit, a field programmable gate array (FPGA), a reconfigurable processor, other suitably programmed or programmable logic circuits, or any combination thereof.

The memory 604 may comprise any suitable known or other machine-readable storage medium. The memory 604 may comprise non-transitory computer readable storage medium, for example, but not limited to, an electronic, magnetic, optical, electromagnetic, infrared, or semiconductor system, apparatus, or device, or any suitable combination of the foregoing. The memory 604 may include a suitable combination of any type of computer memory that is located either internally or externally to device, for example random-access memory (RAM), read-only memory (ROM), electro-optical memory, magneto-optical memory, erasable programmable read-only memory (EPROM), and electrically-erasable programmable read-only memory (EEPROM), Ferroelectric RAM (FRAM) or the like. Memory 604 may comprise any storage means (e.g., devices) suitable for retrievably storing machine-readable instructions 606 executable by processing unit 602.

The methods and systems described herein may be implemented in a high level procedural or object oriented programming or scripting language, or a combination thereof, to communicate with or assist in the operation of a computer system, for example the computing device 600. Alternatively, the methods and systems may be implemented in assembly or machine language. The language may be a compiled or interpreted language. Program code for implementing the methods and systems for detection may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems may also be considered to be implemented by way of a non-transitory computer-readable storage medium having a computer program stored thereon. The computer program may comprise computer-readable instructions which cause a computer, or in some embodiments the processing unit 602 of the computing device 600, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the systems and methods described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A sensing system for a rotor of an engine, the rotor rotatable about a longitudinal axis, the system comprising:
at least one rotating member coupled to rotate with the rotor about the longitudinal axis, the at least one rotating member comprising a core and at least one marker affixed to the core, the core made of a first material having a first magnetic permeability and the at least one marker comprising a second material having a second magnetic permeability greater than the first magnetic permeability;
at least one sensor mounted adjacent the at least one rotating member and configured to produce at least one first signal in response to detecting passage of the at least one marker as the at least one rotating member rotates about the axis; and
a control unit communicatively coupled to the at least one sensor and configured to generate, in response to the at least one first signal received from the at least one sensor, a second signal indicative of at least a rotational speed of the rotor.

2. The sensing system of claim 1, wherein the at least one rotating member comprises at least one blade of the engine.

3. The feedback system of claim 2, wherein the second material is applied to at least a tip of the at least one blade to provide the at least one marker.

4. The feedback system of claim 2, wherein the second material is applied to an entire exposed surface of the at least one blade to provide the at least one marker.

5. The sensing system of claim 1, wherein the rotor is an aircraft-bladed rotor having an adjustable blade pitch angle, and further wherein the at least one rotating member comprises a feedback device coupled to rotate about the longitudinal axis with the rotor and to be displaced axially along the axis with adjustment of the blade pitch angle.

6. The sensing system of claim 5, wherein the feedback device comprises a plurality of detectable features spaced around a circumference thereof, and further wherein at least one of the plurality of detectable features comprises the second material to provide the at least one marker.

7. The sensing system of claim 6, wherein the second material is applied to at least part of the at least one of the plurality of detectable features to provide the at least one marker.

8. The sensing system of claim 6, wherein the plurality of detectable features comprises a first plurality of projections extending from a surface of the feedback device and oriented substantially parallel to the longitudinal axis and at least one second projection extending from the surface and positioned between two adjacent first projections, the at least one second projection disposed on the surface at an angle relative to the first plurality of projections, and further wherein a selected one of the first projections comprises the second material.

9. The sensing system of claim 6, wherein the control unit is configured to generate the second signal indicative of the blade pitch angle and the rotational speed of the rotor.

10. The sensing system of claim 1, wherein the at least one rotating member comprises a torque shaft having a plurality of circumferentially spaced teeth, and further wherein at least one of the plurality of teeth comprises the second material to provide the at least one marker.

11. The sensing system of claim 10, wherein the second material is applied to at least part of the at least one of the plurality of teeth to provide the at least one marker.

12. The sensing system of claim 10, wherein the at least one of the plurality of teeth is fabricated from the second material.

13. The sensing system of claim 1, wherein the at least one marker is provided by one of coating at least part of the at least one rotating member with the second material and plating at least part of the at least one rotating member with the second material.

14. The sensing system of claim 1, wherein the second material has a relative magnetic permeability between 80,000 and 100,000.

15. A sensing method for a rotor of an engine, the rotor rotatable about a longitudinal axis, the method comprising:
receiving at least one first signal from at least one sensor positioned adjacent at least one rotating member, the at least one rotating member coupled to rotate with the rotor about the longitudinal axis and comprising a core and at least one marker made affixed to the core, the core made a first material having a first magnetic permeability and the at least one marker comprising a second material having a second magnetic permeability greater than the first magnetic permeability, the at least one first signal produced by the at least one sensor in response to detecting passage of the at least one marker as the at least one rotating member rotates about the axis; and
processing the at least one first signal to generate a second signal indicative of at least a rotational speed of the rotor.

16. The method of claim 15, wherein the at least one first signal is received from the at least one sensor positioned adjacent the at least one rotating member comprising at least one blade of the engine, the second material applied to at least part of the at least one blade to provide the at least one marker.

17. The method of claim 15, wherein the at least one first signal is received from the at least one sensor positioned adjacent the at least one rotating member comprising a feedback device coupled to rotate about the axis with the rotor and to be displaced axially along the axis with adjustment of a blade pitch angle of the rotor, the feedback device comprising a plurality of detectable features spaced around a circumference thereof, and further wherein at least one of the plurality of detectable features comprises the second material to provide the at least one marker.

18. The method of claim 15, wherein the at least one first signal is received from the at least one sensor positioned adjacent the at least one rotating member comprising a torque shaft having a plurality of circumferentially spaced teeth, at least one of the plurality of teeth comprising the second material to provide the at least one marker.
